(19) United States
(12) Patent Application Publication
(10) Pub. No.: US 2010/0053343 A1
(43) Pub. Date: Mar. 4, 2010

(54) APPARATUS FOR CORRECTING MOTION CAUSED BY HAND SHAKE

(75) Inventors: Hyun KIM, Suwon (KR); Ho Kyoum Kim, Suwon (KR); Ho Seop Jeong, Seongnam (KR); Hyung Chan Kwak, Yongin (KR); In Taek Song, Seongnam (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/510,738

(22) Filed: Jul. 28, 2009

(30) Foreign Application Priority Data
Aug. 26, 2008 (KR) 10-2008-0083593

(51) Int. Cl. H04N 5/228

(52) U.S. Cl. 348/208.4; 348/E05.031

(57) ABSTRACT

An apparatus for correcting motion caused by hand shake performs hand shake correction in due consideration of both linear motion and rotation by detecting linear motion of a capturing device by comparing preceding and subsequent image frames and detecting rotation of the capturing device using a gyro sensor. The apparatus for correcting motion caused by hand shake may include a rotation detection unit detecting the amount of rotation of a capturing device by using a gyro sensor, a linear-motion detection unit comparing preceding and subsequent image frames generated by an image sensor unit to detect the amount of linear motion of the capturing device, and an output image determination unit correcting the detected amount of rotation and the detected amount of linear motion in an image frame input from the image sensor to generate a corrected output image frame.

### CROSS-REFERENCE TO RELATED APPLICATIONS

This application claims the priority of Korean Patent Application No. 2008-83593 filed on Aug. 26, 2008, in the Korean Intellectual Property Office, the disclosure of which is incorporated herein by reference.

### BACKGROUND OF THE INVENTION

1. Field of the Invention

The present invention relates to a digital image processing field, and more particularly, to an apparatus for correcting motion caused by hand shake, which can perform hand shake correction in due consideration of both linear motion and rotation by detecting the linear motion of a capturing device by comparing preceding and subsequent image frames, and detecting rotation of the capturing device by use of a gyro sensor.

2. Description of the Related Art

A camera module being used in a mobile terminal such as a portable phone is required to have more pixels and a smaller volume. To meet the demand for more pixels, the pixel size of an image sensor is reduced so that a high pixel resolution can be realized within a limited area such as that of the image sensor.

The small pixel size of the sensor causes the image sharpness of a still image to drastically decrease even with slight shaking of a camera module resulting from, e.g., hand shake when a user operates a shutter. At the time of capturing a video, even though the pixel size of the image sensor is not small, camera shake may continue as the user moves or due to the length of recording time. Only an expert-level user is able to capture a video without creating undesired motion caused by hand shake, while a general user creates unintended shakiness of inter-frame images. With the recent rapid distribution of high-definition (HD) televisions, recording an HD video is more generalized than recording a standard-definition (SD) video. For an HD video, the motion caused by hand shake needs to be corrected at a even higher speed since an HD image has more pixels than an SD image.

### SUMMARY OF THE INVENTION

An aspect of the present invention provides an apparatus for correcting motion caused by hand shake in due consideration of both rotation and linear motion by detecting the amount of rotation of a capturing device caused by hand shake by use of a gyro sensor that detects the angular velocity, and also detecting the amount of linear motion of the capturing device calculated by comparing image frames input from an image sensor.

According to an aspect of the present invention, there is provided an apparatus for correcting motion caused by hand shake, including: a rotation detection unit detecting the amount of rotation of a capturing device by use of a gyro sensor; a linear-motion detection unit comparing preceding and subsequent image frames generated by an image sensor to detect the amount of linear motion of the capturing device; and an output image determination unit correcting the detected amount of rotation and the detected amount of linear motion in an image frame input from the image sensor to generate a corrected output image frame.

The rotation detection unit may include: a gyro sensor detecting the amount of rotation around a plurality of rotation axes; an analog-digital converter converting the detected amount of rotation around the plurality of rotation axes into respective digital values; a memory storing the converted digital values; and a micro controller storing the converted digital values in the memory and reading the digital values stored in the memory to output the digital values to the output image determination unit.

The linear-motion detection unit may include: an image processor processing a signal input from the image sensor to generate the image frame; a frame buffer temporally storing the image frame; and a linear-motion calculator comparing preceding and subsequent image frames stored in the frame buffer to calculate the amount of linear motion in directions of a plurality of coordinate axes.

The gyro sensor may be a 3-axis gyro sensor that detects the amount of pitch, the amount of yaw, and the amount of roll, or a 2-axis gyro sensor that detects the amount of pitch and the amount of yaw.

The linear-motion detection unit may detect the amount of motion in a direction of a horizontal coordinate axis, an x-axis of the capturing device, the amount of motion in a direction of a vertical coordinate axis, a y-axis of the capturing device, and the amount of motion in a direction of a longitudinal coordinate axis, a z-axis of the capturing device. Alternatively, the linear motion detection unit may detect the amount of motion in a horizontal coordinate axis, an x-axis of the capturing device, and the amount of motion in a vertical coordinate axis, a y-axis of the capturing device.

The output image determination part may calculate, in units of pixels, the correction amounts in horizontal and vertical directions by using the detected amount of rotation and the detected amount of linear motion, and determine an area for the output image frame by using the correction amounts in the horizontal and vertical directions calculated in units of pixels.

The output image determination part may determine the area for the output image frame in the input image frame by determining a starting pixel of an output image frame of a predetermined size using the correction amounts in the horizontal and vertical directions.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram showing an apparatus for correcting motion caused by hand shake according to an exemplary embodiment of the present invention;

FIGS. 2A through 2C are views showing rotation of a capturing device detected by a gyro sensor;

FIGS. 3A through 3C are views showing linear motion of the capturing device detected by a linear-motion detection unit;

FIGS. 4A and 4B are views showing rotation and linear motion that the capturing device undergoes simultaneously; and

FIG. 5 is a method for correcting motion caused by hand shake, according to an exemplary embodiment of the present invention.

### DETAILED DESCRIPTION OF THE PREFERRED EMBODIMENT

Exemplary embodiments of the present invention will now be described in detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. In the figures, the dimensions and shapes of the elements are exaggerated for clarity of illustration.

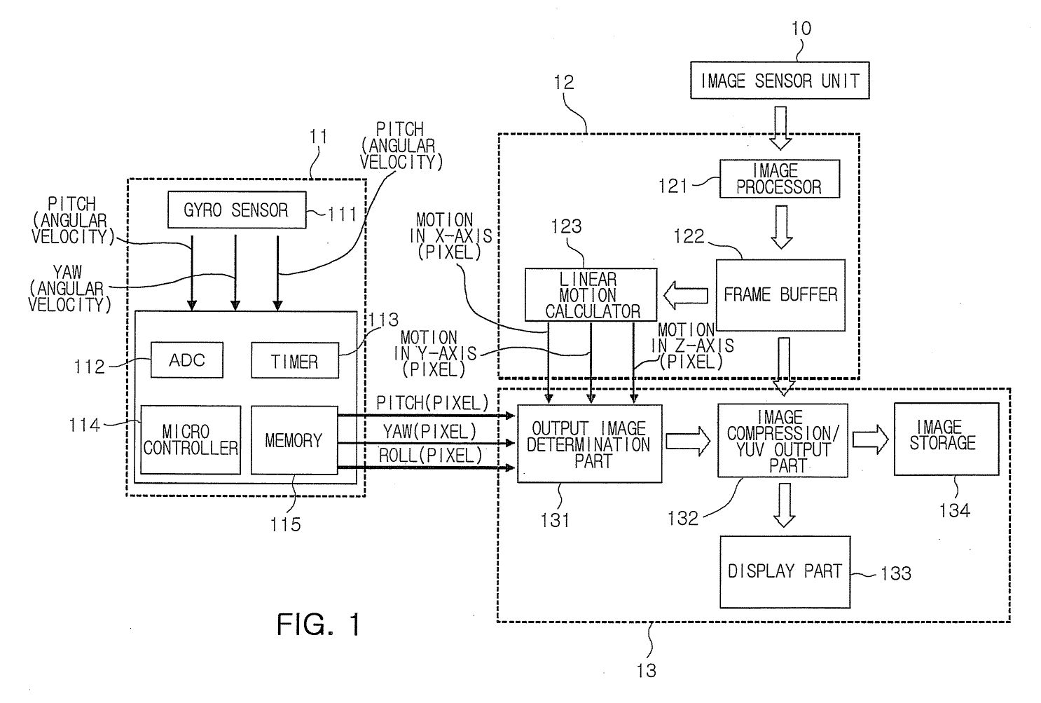

FIG. 1 is a block diagram of an apparatus for correcting motion caused by hand shake, according to an exemplary embodiment of the present invention. Referring to FIG. 1, the apparatus for correcting motion caused by hand shake includes a rotation detection unit 11, a linear-motion detection unit 12, and a hand shake correction unit 13.

The rotation detection unit 11 may detect the amount of rotation of a capturing device by use of a gyro sensor. In more detail, the rotation detection unit 11 may include a gyro sensor 111, an analog-digital converter (ADC) 112, a memory 115, and a micro controller 114. The gyro sensor 111 detects the amount of rotation around multiple rotation axes. The ADC 112 converts the detected amount of rotation around the multiple rotation axes into respective digital values. The memory 115 stores the converted digital values. The micro controller 114 stores the converted digital values in the memory 115 and reads the digital values stored in the memory 115 to output them to the hand shake correction unit 13. The rotation detection unit 11 may further include a timer 113 that provides a sampling time for the analog-to-digital conversion of the ADC 112.

The linear-motion detection unit 12 may include an image processor 121, a frame buffer 122, and a linear-motion calculator 123. The image processor 121 processes a signal input from an image sensor unit 10 to generate an image frame. The frame buffer 122 temporarily stores the image frame. The linear-motion calculator 123 compares preceding and subsequent image frames stored in the frame buffer 122 to calculate the amount of linear motion in the directions of a plurality of coordinate axes.

The hand shake correction unit 13 may include an output image determination part 131, an image compression/YUV output part 132, a display part 133, and an image storage 134. The output image determination part 131 corrects the amount of rotation detected by the rotation detection unit 11 and the amount of linear motion detected by the linear-motion detection unit 12 in an input image frame to generate a corrected output image frame. The image compression/YUV output part 132 compresses consecutive output image frames or outputs them as YUV signals. The display part 133 displays each of the YUV signals. The image storage 134 stores the compressed image frames.

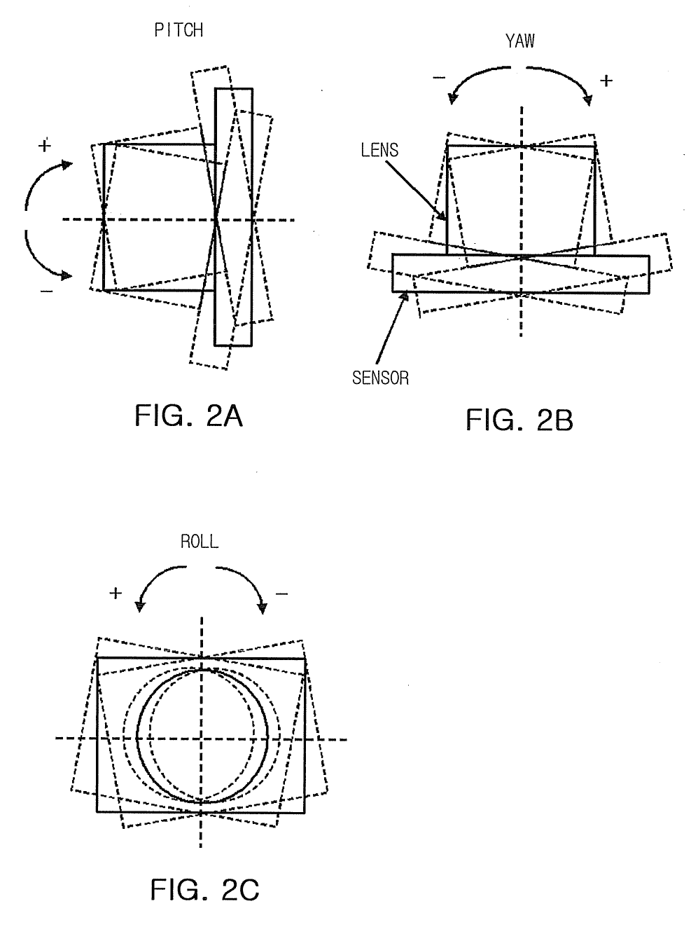

FIGS. 2A through 2C are views illustrating rotation of a capturing device detected by the gyro sensor.

As shown in FIG. 2A, the gyro sensor 111 in the rotation detection unit 11 may detect pitch that refers to rotation around a horizontal coordinate axis, i.e., an x-axis passing one point of a capturing device (or a camera module). As shown in FIG. 2B, the gyro sensor 111 may detect yaw that refers to horizontal rotation around a vertical coordinate axis, i.e., a y-axis passing one point of the capturing device (or the camera module). As shown in FIG. 2C, the gyro sensor 111 may detect roll that refers to rotation around a longitudinal (front-to-back) coordinate axis, i.e., an optical axis or a z-axis passing one point of the capturing device (or the camera module). According to the exemplary embodiment of the present invention, a 2-axis gyro sensor may be used as the gyro sensor 111. The 2-axis gyro sensor detects the amount of rotation around two coordinate axes, pitch and yaw. Here, the pitch and the yaw are the representative movement in a two-dimensional image frame. For more accurate hand shake correction, a 3-axis gyro sensor may be used, which detects the amount of rotation around all of the three coordinate axes, pitch, yaw, and roll.

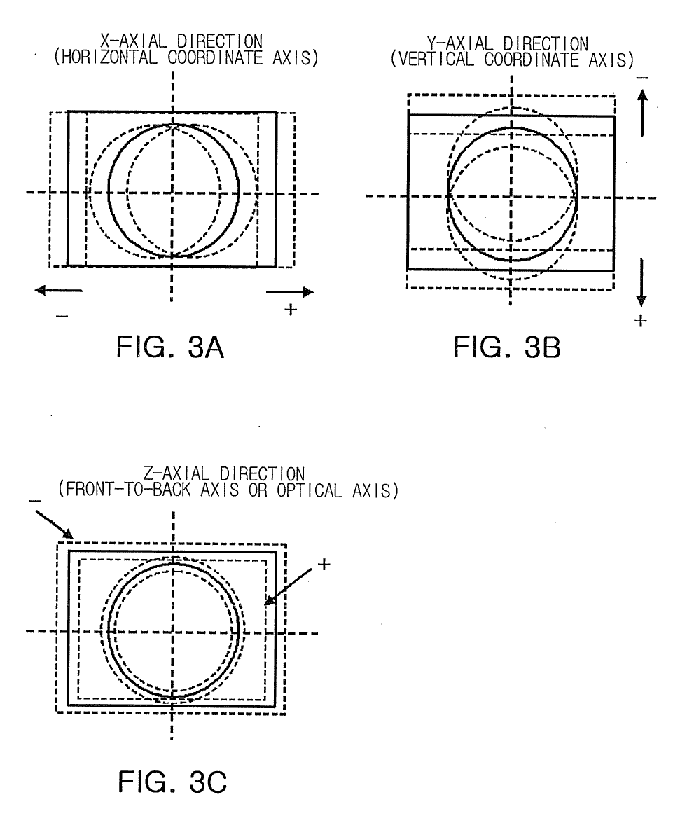

FIGS. 3A through 3C are views illustrating linear motion of the capturing device detected by the linear-motion detection unit 12. As shown in FIG. 3A, the linear-motion detection unit 12 may detect the amount of motion in a direction of the horizontal coordinate axis, i.e., the x-axis of the capturing device (or the camera module), the amount of motion in a direction of the vertical coordinate axis, i.e., the y-axis of the capturing device (or the camera module), and the amount of motion in a direction of the longitudinal coordinate axis, i.e., the optical axis or the z-axis of the capturing device (or the camera module). To simplify the calculation, the linear-motion detection unit 12 may detect the amount of motion in two axial directions, the motion in the x-axial direction and the motion in the y-axial direction, which are representative movement in a two-dimensional image frame. To achieve more accurate hand shake correction, the linear-motion detection unit 12 may detect the amount of linear motion in the three axial directions. If the gyro sensor 111 of the rotation detection unit 11 detects the amount of rotation about all the three axes, the linear-motion detection unit 12 may also detect the amount of linear motion in the three axial directions. If the gyro sensor 111 of the rotation detection unit 11 detects the amount of rotation about the two axes, the linear-motion detection unit 12 may also detect the amount of linear motion in the two axial directions.

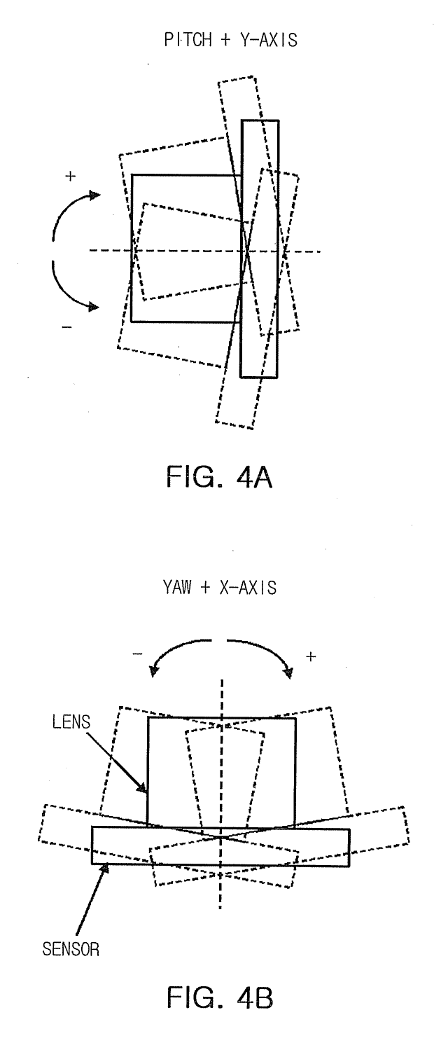

FIGS. 4A and 4B are views showing rotation and linear motion that the capturing device undergoes simultaneously. As shown in FIGS. 4A and 4B, the movement of the capturing device caused by hand shake includes both rotation and linear motion. Thus, the effects of the hand shake correction can be significantly improved by calculating and correcting the respective amounts of rotation and linear motion.

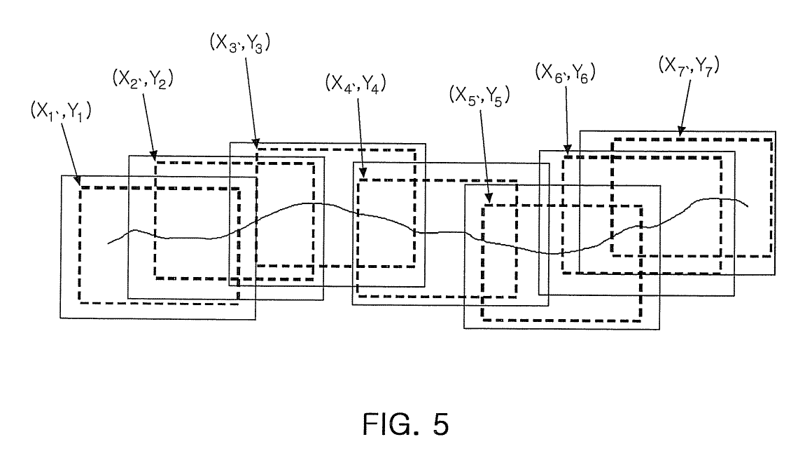

FIG. 5 is a view for explaining a method for correcting motion caused by hand shake. In FIG. 5, rectangles indicated by solid lines indicate input image frames, and rectangles indicated by dotted lines indicate output image frames. According to an exemplary embodiment of the present invention, the output image determination part 131 of the hand shake correction unit 13 determines an area for an output image frame to correct the amount of rotation and the amount of linear motion detected in each input image frame, and outputs the corrected output image frame. In more detail, the output image determination part 131 may calculate in units of pixels the transitional amount of horizontal and vertical coordinates of the input image frame corresponding to the detected amount of rotation and the amount of linear motion. Thereafter, the output image determination part 131 may determine an area for an output image frame compensating for the transitional amount of the horizontal and vertical coordinates calculated in units of pixels. The output image determination part 131 may determine the area for an output image frame in the input image frame by determining a starting pixel of the output image frame of predetermined size.

Operations and effects of the exemplary embodiment of the present invention will now be described in more detail with reference to accompanying drawings.

The apparatus for correcting motion caused by hand shake may be used in capturing a video while using a camcorder or the camera module of a mobile phone. The apparatus for correcting motion caused by hand shake generates and outputs an output image frame that can correct the amount of rotation and the amount of linear motion for each input image frame generated by the image sensor unit 10.

When the video capturing begins, the gyro sensor 111 of the rotation detection unit 11 may detect the amount of rotation of the capturing device (e.g., a camcorder or a camera module), and the ADC 112 may convert the detected amount of rotation into a digital value at a sampling interval determined by the timer 113. The micro controller 114 may add up the amount of rotation input as digital values for each predetermined time period, and store it in the memory 115. The amount of rotation detected and output from the gyro sensor 111 may correspond to the angular velocity. The micro controller 114 may read the digital value representing the amount of rotation and stored in the memory 115, and output it to the hand shake correction unit 13. If the gyro sensor 11 is a 3-axis gyro sensor, the respective amounts of pitch, yaw and roll may be stored and output. If the gyro sensor 11 is a 2-axis gyro sensor, the respective amounts of pitch and yaw may be stored and output. The time period of the adding may correspond to a frame interval considering that the hand shake correction is performed in units of image frames. The micro controller 114 may read the amount of rotation corresponding to the angular velocity stored in the memory 115, convert it into the amount of rotation corresponding to a pixel of an image, and output the converted amount.

While the rotation detection unit 11 operates, the linear-motion detection unit 12 may also detect the linear motion of the capturing device (e.g., a camcorder or a camera module) by using an input image frame. A signal captured by the image sensor unit 10 undergoes a series of image processing processes performed by the image processor 121 to be output as an input image frame. This input image frame may be temporally stored in the frame buffer 122. The linear-motion calculator 123 compares preceding and subsequent input image frames stored in the frame buffer 122 to determine whether linear motion occurs, and detects the amount of linear motion. Various known-techniques may be used to determine the presence of linear motion and detect the amount of motion through comparison between image frames. The linear-motion calculator 123 may output the amount of motion in the directions of three coordinate axes in units of pixels, or output the amount of motion in the directions of two coordinate axes, the horizontal axis (i.e., the x-axis) and the vertical axis (i.e., the y-axis) in units of pixels.

The amount of rotation output by the micro controller 114 of the rotation detection unit 11 and expressed in units of pixels, and the amount of linear motion output by the linear-motion calculator 123 of the linear-motion detection unit 112 and expressed in units of pixels are input to the output image determination part 131 of the hand shake correction unit 13. Thus, the output image determination part 131 calculates the correction amount in horizontal and vertical directions, which are to be used in correcting the input image frame. For example, the respective correction amounts in the horizontal and vertical directions are calculated as expressed in the following Equations 1 and 2 in an embodiment in which a 3-axis gyro sensor is used as the gyro sensor 111, and the linear-motion detection unit 12 detects the amount of linear motion in three directions. The respective correction amounts in the horizontal and vertical directions are calculated as expressed in Equations 3 and 4 in an embodiment in which a 2-axis gyro sensor is used and the linear-motion detection unit 12 detects the amount of linear motion in two directions.

X_{shift}=X_{yaw}+Xᵣₒₗₗ+Xₓ_{_{—}}ₜᵣₐₙₛ+X_{z}_{_{—}}ₜᵣₐₙₛ (Eq. 1)

Y_{shift}=Y_{pitch}+Yᵣₒₗₗ₊Y_{y}_{_{—}}ₜᵣₐₙₛ+Y_{z}_{_{—}}ₜᵣₐₙₛ (Eq. 2)

X_{shift}=X_{yaw}+Xₓ_{_{—}}ₜᵣₐₙₛ (Eq. 3)

Y_{shift}=Y_{pitch}+Y_{y}_{_{—}}ₜᵣₐₙₛ (Eq. 4)

In Equations 1 through 4 above, X_{shift} and Y_{shift} represent the correction amount in the horizontal and vertical directions, respectively, X_{yaw} represents a value obtained by converting the amount of yaw in units of pixels, Xᵣₒₗₗ represents a value obtained by converting a horizontal component in the amount of roll in units of pixels, Xₓ_{_{—}}ₜᵣₐₙₛ represents the amount of linear motion in the horizontal coordinate axis (i.e., the x-axis), and X_{z}_{_{—}}ₜᵣₐₙₛ represents a value corresponding to a horizontal component of the amount of linear motion in the longitudinal axis (i.e., the optical axis or the z-axis). Similarly, Y_{pitch} is a value obtained by converting the amount of pitch in units of pixels, Yᵣₒₗₗ is a value obtained by converting a vertical component of the amount of roll, Y_{y}_{_{—}}ₜᵣₐₙₛ is the amount of linear motion in the vertical coordinate axis (i.e., the y-axis), and Y_{z}_{_{—}}ₜᵣₐₙₛ is a value corresponding to a vertical component of the amount of linear motion in the longitudinal axis (i.e., the optical axis or the z-axis). [0035] The correction amounts in the horizontal and vertical directions calculated in the above manner may be used for the output image determination part 131 to determine an output image frame. The output image determination part 131 uses the correction amounts in the horizontal and vertical directions to correct the motion caused by hand shake and generate a corrected output image frame. For example, as shown in FIG. 5, the output image frame (see a rectangle indicated by dotted lines) is a frame that has less pixels than the input image frame (see a rectangle indicated by a solid line). The size of the output image frame may be determined beforehand. As described above, the output image determination part 131 may change starting coordinates ((X₁, Y₁) to (X₇, Y₇)) of an output image frame for each input image frame by the calculated correction amounts in the horizontal and vertical directions, and output the output image frame. Thus, the output image determination part 131 can output an image frame where the motion caused by hand shake is corrected.

As described so far, according to the present invention, the motion caused by hand shake is corrected in due consideration of the amount of rotation detected by the gyro sensor and the amount of linear motion detected by digital processing of an image, thereby significantly improving the effect of hand shake correction in outputting a video.

According to the present invention, accuracy in correction can be significantly improved by correcting hand shake in due consideration of the amount of rotation detected by the gyro sensor and the amount of linear motion detected by digital processing of an image.

While the present invention has been shown and described in connection with the exemplary embodiments, it will be apparent to those skilled in the art that modifications and variations can be made without departing from the spirit and scope of the invention as defined by the appended claims.

What is claimed is:

1. An apparatus for correcting motion caused by hand shake, the apparatus comprising:
a rotation detection unit detecting the amount of rotation of a capturing device by use of a gyro sensor;
a linear-motion detection unit comparing preceding and subsequent image frames generated by an image sensor unit to detect the amount of linear motion of the capturing device; and
an output image determination unit correcting the detected amount of rotation and the detected amount of linear motion in an image frame input from the image sensor unit to generate a corrected output image frame.

2. The apparatus of claim 1, wherein the rotation detection unit comprises:
a gyro sensor detecting the amount of rotation around a plurality of rotation axes;
an analog-digital converter converting the detected amount of rotation around the plurality of rotation axes into respective digital values;
a memory storing the converted digital values; and
a micro controller storing the converted digital values in the memory and reading the digital values stored in the memory to output the digital values to the output image determination unit.

3 The apparatus of claim 1, wherein the linear-motion detection unit comprises:
an image processor processing a signal input from the image sensor unit to generate the image frame;
a frame buffer temporally storing the image frame; and
a linear-motion calculator comparing preceding and subsequent image frames stored in the frame buffer to calculate the amount of linear motion in directions of a plurality of coordinate axes.

4. The apparatus of claim 1, wherein the gyro sensor is a 3-axis gyro sensor that detects the amount of pitch, the amount of yaw, and the amount of roll.

5. The apparatus of claim 1, wherein the linear-motion detection unit detects the amount of motion in a direction of a horizontal coordinate axis, an x-axis of the capturing device, the amount of motion in a direction of a vertical coordinate axis, a y-axis of the capturing device, and the amount of motion in a direction of a longitudinal coordinate axis, a z-axis of the capturing device.

6. The apparatus of claim 1, wherein the gyro sensor is a 2-axis gyro sensor that detects the amount of pitch and the amount of yaw.

7. The apparatus of claim 1, wherein the linear motion detection unit detects the amount of motion in a horizontal coordinate axis, an x-axis of the capturing device, and the amount of motion in a vertical coordinate axis, a y-axis of the capturing device.

8. The apparatus of claim 1, wherein the output image determination part calculates, in units of pixels, the correction amounts in horizontal and vertical directions by using the detected amount of rotation and the detected amount of linear motion, and determines an area for the output image frame by using the correction amounts in the horizontal and vertical directions calculated in units of pixels.

9. The apparatus of claim 8, wherein the output image determination part determines the area for the output image frame in the input image frame by determining a starting pixel of an output image frame of a predetermined size using the correction amounts in the horizontal and vertical directions.
